(19) United States
(12) Patent Application Publication
(10) Pub. No.: US 2026/0310307 A1
(43) Pub. Date: Oct. 8, 2026

(54) JAPANESE PC KEYBOARD AND GAMING KEYBOARD

(71) Applicants: Jong Heon LEE, Seoul (KR); Si Yeung LEE, Seoul (KR); In Oak KO, Seoul (KR)

(72) Inventors: Jong Heon LEE, Seoul (KR); Si Yeung LEE, Seoul (KR); In Oak KO, Seoul (KR)

(21) Appl. No.: 19/480,249

(22) PCT Filed: Feb. 9, 2023
(86) PCT No.: PCT/KR2023/001892

§ 371 Date: Oct. 30, 2025

(30) Foreign Application Priority Data
Feb. 11, 2022 (KR) 10-2022-0017846

(51) Int. Cl. G06F 3/02; G06F 3/01

(52) U.S. Cl. CPC G06F 3/0219; G06F 3/018; G06F 3/0213

(57) ABSTRACT

Disclosed in the present invention is a Japanese input device, wherein the Japanese input device comprises a first portion for inputting consonants and a second portion for inputting vowels, and comprises silent keys indicating Japanese syllables in combination with [symbol] keys in the second portion. The Japanese input device may be implemented by being included in a PC keyboard or a gaming keyboard.

### TECHNICAL FIELD

The present invention relates to a Japanese input device and input method, and a PC keyboard and a gaming keyboard including the Japanese input device.

### BACKGROUND ART

Hangeul, created with Hunminjeongeum, is the most scientific language that expresses sounds, consisting of initial, medial, and final consonants. In Korea, publications have been produced by printing each letter with an imprint, as seen in metal type from ancient times. As typing machines have been invented in the West, keyboards have been used as input devices, and the order of the keys on these keyboards remains the same as the English keyboards used on computers today. As the keyboards have been introduced into the country, keyboards with consonants on the left and vowels on the right have become widely used in Korea, depending on the frequency of use of Hangeul and the convenience of input. In accordance with the recent proliferation of smartphones, various types of simple screen input devices have become widespread, but based on the evolution of character input devices, it can be seen that there is room for more improvement and revolution than any other field.

On the other hand, from a global perspective, it is not easy to implement a unified character input device because each country's character input method may vary depending on its own traditional characters, language, and lifestyle. However, it is possible to impart unity and convenience to the input of foreign language characters by using the universality of the science and structure of Hangeul. The present invention applies the universality of the science and structure of Hangeul to the Japanese language.

More specifically, the present invention relates to an input device and an input method capable of intuitively determining Japanese through an input device such as a mobile phone, a computer keyboard, etc., and quickly inputting the Japanese using a method different from an existing input system.

The input device of a smartphone, which is currently and widely used as a Japanese character input device, has a structure of 4 rows×5 columns, as shown in FIG. 5. To input [symbol] (a; Korean pronunciation) using the input device, press the [symbol] key once. However, to input [symbol] (o), press the [symbol] key five times because there is no [symbol] key. The vowel order of Japanese is “a, i, u, e, and o”, and only the representative first vowel, “a” is set to a key, and the remaining vowels are displayed by repeatedly pressing the representative key. To input [symbol] with the input device, it is required to press the [symbol] key five times to display [symbol] (ho), find and press the [symbol] key, and then press the [symbol] (ta) key three times to convert the same into [symbol] (tsu), and press the key to convert the same to a lowercase letter [symbol] To this end, a total of 11 key inputs are required.

Therefore, the current Japanese character input device is inconvenient not only for Japanese people but also for foreigners, takes time to type, and has a high risk of typos when the representative key must be pressed multiple times.

To solve the inconvenience of inputting Japanese characters, disclosed is a patent for inputting Japanese characters by dividing the same into consonants and vowels.

Korean Patent No. 10-1426643 (registered on Jul. 29, 2014) discloses an input device in which a consonant key group 11′ including alphabet consonant keys “K”, “H”, “N”, “T”, “S”, “W”, and the like and a vowel key group 12′ including alphabet vowel keys “A”, “I”, “U”, “E”, “O”, “Y” are arranged, a central input keys 11a′ and 12a′ are arranged in the center of the input device, and a plurality of peripheral input keys 11b′ and 12b′ are arranged around the central input keys 11a′ and 12a′, as shown in FIG. 6. When the central input key 11a′ is pressed, new consonants of “M” “R” “P” “T” and “V” are displayed on the peripheral input key 11b′. Reference numerals 11c′ and 12c′ refer to border keys for switching keys. However, in the patent, it is cumbersome to display consonants, and does not consider at all the handling of a silent word “O” as described later.

Korean Unexamined Patent Publication No. 10-2014-0050796 discloses a keypad arrangement in which keys for indicating vowels are arranged on the left side of a keyboard, keys for indicating consonants are arranged on the remaining portions, and the consonant keys are repeatedly pressed to display a voiced sound and a clipped sound, as shown in FIG. 7. However, in the patent, it also does not consider at all the handling of the silent word [symbol] In addition, since a design of the keyboard focuses on simplicity, there is a disadvantage in that the keyboard is inconvenient to input semivowels that are widely used in Japanese language, such as [symbol] (ya), [symbol] (yu), [symbol] (yo), [symbol] (wa), and [symbol] (o).

The above-described patents exemplify a Roman keyboard as an input device, and there is a lack of scalability and universality that may be applied to foreigners who are not familiar with Roman characters and Japanese or Korean people who are familiar with unique characters.

Based on this point, the present inventors have developed a new configuration of a Japanese PC keyboard and a gaming keyboard to solve the problems of the current technology and prior patents and to input Japanese characters quickly and accurately.

### DISCLOSURE

### Technical Problem

Therefore, an object of the present invention is to provide a Japanese input device and an input method capable of intuitively determining Japanese through an input device such as a computer keyboard and a gaming keyboard and inputting Japanese quickly and without typos using a method different from an existing input system.

### Technical Solution

To achieve the above object, the present invention provides a PC keyboard including a Japanese input device, in which the Japanese input device includes: a first portion for inputting consonants; a second portion for inputting vowels; and a silent key for indicating Japanese syllables in combination with keys [symbol] in the second portion, the Japanese syllables are indicated using (a) consonant keys in the first portion and vowel keys in the second portion, or (b) the silent key and the vowel keys in the second portion, in which the syllables are not indicated when only one vowel key in the second portion is used, and the consonant keys in the first portion and the vowel keys in the second portion are installed to correspond to English keys of the PC keyboard, and the first portion and the second portion are arranged such that a region surrounding the first portion and a region surrounding the second portion do not cross or overlap each other to allow the first portion and the second portion to occupy independent regions on the PC keyboard, respectively.

The consonant keys in the first portion, the vowel keys in the second portion, and the silent key may be installed to correspond to the English keys of the PC keyboard.

The consonant keys in the first portion may consist of at least 15 keys including keys

[symbol]

The vowel keys in the second portion may consist of at least 10 keys including the keys

[symbol]

In addition, the present invention provides a PC keyboard including a Japanese input device, in which the Japanese input device includes: a first portion for inputting consonants; a second portion for inputting vowels; and a silent key for indicating Japanese syllables in combination with keys [symbol] in the second portion, the Japanese syllables are indicated using (a) consonant keys in the first portion and vowel keys in the second portion, or (b) the silent key and the vowel keys in the second portion, in which the syllables are not indicated when only one vowel key in the second portion is used, and the Japanese input device is installed at a position that does not overlap with the English keys of the PC keyboard, and the first portion and the second portion are arranged to allow the first portion and the second portion to occupy independent regions on the PC keyboard, respectively.

The first portion may be arranged on one side of the PC keyboard, the second portion may be arranged on the other side the PC keyboard, and the English keys may be arranged in an intermediate region between the first portion and the second portion.

In addition, the present invention provides a gaming keyboard including a Japanese input device, in which the Japanese input device includes: a first portion for inputting consonants; a second portion for inputting vowels; and a silent key for indicating Japanese syllables in combination with keys [symbol] in the second portion, the Japanese syllables are indicated using (a) consonant keys in the first portion and vowel keys in the second portion, or (b) the silent key and the vowel keys in the second portion, in which the syllables are not indicated when only one vowel key in the second portion is used, and the consonant keys in the first portion and the vowel keys in the second portion are arranged to allow the consonant keys and the vowel keys to occupy independent regions on the gaming keyboard, respectively.

The first portion may be arranged on one side of the gaming keyboard, the second portion may be arranged on the other side of the gaming keyboard, and a game-dedicated key or a controller may be installed in an intermediate region between the first portion and the second portion.

### Advantageous Effects

The Japanese input device of the present invention inputs Japanese syllables based on combinations of consonants and vowels so that it is possible to maintain the consistency of the input method, and by inputting Japanese intuitively and easily, it is possible to provide a convenient Japanese input device with fewer typos.

The Japanese input device of the present invention has scalability and versatility, which may be widely applied to a mobile device such as a smartphone, a position fixed-type computer, a physical keyboard, a touch board, and a gaming keyboard.

### DESCRIPTION OF DRAWINGS

FIG. 1 is a view showing a Japanese input device according to a preferred embodiment of the present invention.

FIG. 2 is a view of a PC keyboard including the Japanese input device of the present invention.

FIG. 3 is a view of another embodiment of a PC keyboard including the Japanese input device of the present invention.

FIG. 4 is a view of still another embodiment of a keyboard including the Japanese input device of the present invention, which may be utilized as a gaming keyboard.

FIG. 5 is a view showing a Japanese input device of a prior art.

FIG. 6 is a view showing a Japanese input device of a prior patent.

FIG. 7 is a view showing a Japanese input device of another prior patent.

### MODE FOR INVENTION

Hereinafter, preferred embodiments of the present invention will be described with reference to the accompanying drawings.

One of the features of the present invention is the input of the five basic vowels

[symbol] (a; Korean pronunciation), [symbol] (i), [symbol] (u), [symbol] (e), and “ [symbol] ”(o) located in the [symbol] row of Japanese. The respective basic vowels are five vowels based on a silent word [symbol] (ng). However, when the vowels are used with consonants such as “na”, “ni”, “nu”, “ne”, and “no”, each syllable is mixed into the consonant and loses its original silent word. However, in Japanese language, the five basic vowels often need to be represented as syllables with an independent silent word, so it is reasonable and convenient to use a unique input method.

The “Japanese input device” of the present invention includes not only a mobile device such as a smartphone and a keyboard of a computer, but also an on-screen keyboard and a virtual keyboard displayed on a screen of the devices, and an input device in which only the keyboard is separately modularized, and needs to be interpreted as broadly as possible.

### Embodiment for Keyboard of Smartphone

Hereinafter, an embodiment of a keyboard of a smartphone is the same as a part of the contents disclosed in Korean Registered Patent No. 10-2459508 (filed on Jan. 13, 2022/registered on Oct. 24, 2022). The contents of the present embodiment support the embodiments of the PC keyboard and the gaming keyboard of the present invention, and thus will be described first.

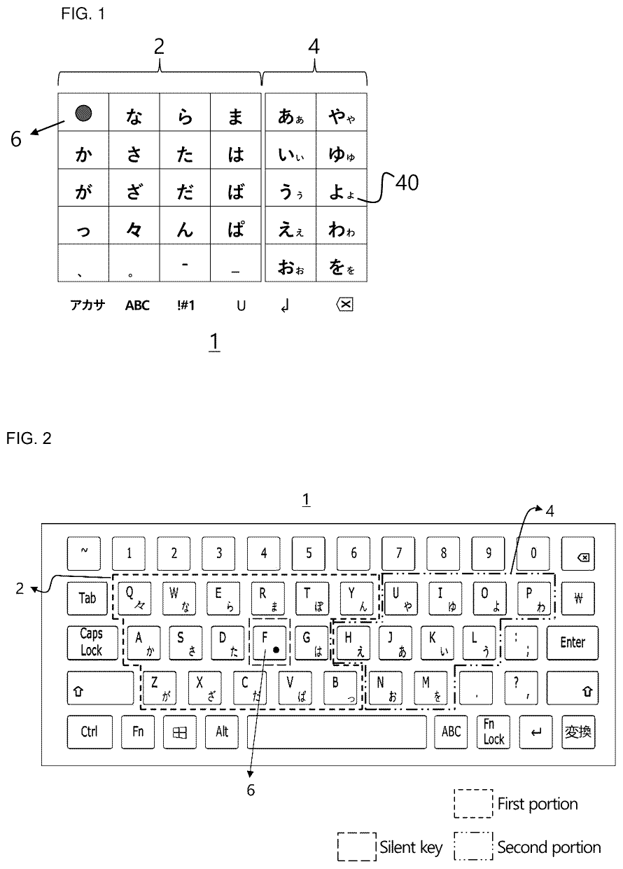

FIG. 1 is a view of a Japanese input device 1 according to a preferred embodiment of the present invention. The Japanese input device 1 of the present invention is described based on an example suitable for a display of the smartphone for convenience, but the present invention is not limited thereto.

The Japanese input device 1 of the present invention has a structure of 5 rows×6 columns, and is not significantly different from the current input device frame, and thus may be applied to the current technology as it is. The Japanese input device 1 includes a first portion 2 on a left side thereof for mainly inputting consonants and a second portion 4 on a right side thereof for mainly inputting vowels.

The first portion 2 has a structure of 5 rows×4 columns, and a silent key 6 for indicating a silent word is indicated by “•” in the first row and the first column. Keys [symbol] [symbol] are arranged in the second to fourth columns of the first row. Keys [symbol] [symbol] are arranged in the first to fourth columns of the second row. Keys [symbol] [symbol] are arranged in the first to fourth columns of the third row. Keys [symbol] [symbol] (iteration mark), [symbol] are arranged in the first to fourth columns of the fourth row. Symbol keys indicating periods, commas, and lines are arranged in the fifth row. It should be noted that each of consonant keys arranged in the first portion 2 is for indicating a representative consonant representing each sound, and the Japanese displayed on the corresponding key is not immediately input by a single input of the key.

These arrangements are optimally formed through the study of the present inventor reflecting the order of 50 phonograms of Japanese, the frequency of use, and user convenience, but various changes are possible within the scope of the present invention.

The second portion 4 has a structure of 5 rows×2 columns, and keys [symbol] [symbol] which are basic vowels, are arranged in the first column. The second column contains semivowels, and keys [symbol] are arranged therein. An auxiliary character 40 indicated by a lowercase letter is displayed in parallel in each vowel key in the second portion 4, which is intended to inform that a vowel, which is a lowercase letter, is input when the corresponding key is pressed twice, as will be described later.

To input [symbol] using the Japanese input device of the present invention, press the silent key 6, and then press the [symbol] key. To input [symbol] press the silent key 6, and the press the [symbol] key. The same applies to [symbol] As described above, the present invention combines the basic vowels located in the [symbol] row of Japanese language in combination with the silent key 6. Since the input of the silent key 6 is the same as inputting a “consonant”, which is a silent sound, like an initial consonant, the vowel is a medial consonant, and since the consistency of completing the syllable with two key inputs may be maintained in the Japanese input device, it is phonetically reasonable and very convenient for the user and intuitive. Such a principle applies equally to the five basic vowels as well as the keys [symbol] [symbol] in the second row.

Those skilled in the art will easily understand how to create vowels and consonants using the Japanese input device of the present invention; for example, to input [symbol] press the [symbol] key, and then press the [symbol] key. To input [symbol] press the [symbol] key, and then press the [symbol] key. To input [symbol] press the [symbol] key, and then press the [symbol] key. In this way, in addition to the silent key 6, the input method of “consonant” and “vowel” may be consistently applied to most Japanese languages.

That is, since most of the vowel sounds in Japanese pronunciation correspond to the Korean language “a, i, u, e, and o”, when the five basic vowels corresponding to “a, i, u, e, and o”, the keys [symbol] are placed in the first column in the second portion 4, Japanese syllables without final consonants may be typed with 2 strokes, which is very fast and convenient.

In addition, in the present invention, the characters corresponding to the final consonants of Hangeul, such as [symbol] and other [symbol] are arranged as independent keys such that [symbol] may be input with a single press. Although not shown, the Japanese character [symbol] which appears frequently, may be arranged as an independent key such that [symbol] may be input with one stroke.

According to the Japanese input device of the present invention having such a configuration, most Japanese languages may be input within 2 to 3 strokes through the consonant arrangement in the first portion 2, the vowel arrangement in the second portion 4, the silent key 6, and the arrangement of independent key input characters in the first portion 2.

That is, in the present invention, Japanese syllables are indicated only using (a) the consonant keys in the first portion and the vowel keys in the second portion or (b) the silent key and the vowel keys in the second portion, and no syllable is indicated using a single vowel key in the second portion.

Next, a method for inputting small vowels (lowercase letters) using the Japanese input device of the present invention will be described.

For example, To input [symbol] instead of [symbol] when the [symbol] key is pressed followed by the [symbol] key, [symbol] is input (see vowel and consonant combinations described above). Next, to input [symbol] press the silent key 6 followed by the [symbol] key (see vowel input using the silent key described above). Then, the word [symbol] is input with a total of 4 key presses. In addition, when the [symbol] key is continuously pressed, the [symbol] is changed to a lowercase letter and the word [symbol] is input, which is sufficient with a total of 5 key presses.

To input only vowels of lowercase letters, for example, when the lowercase letter [symbol] is input, press the “silent key 6” followed by the [symbol] key twice in succession to input [symbol] .

Although the Japanese input device of the present invention described above is based on hiragana, the same explanation applies to katakana as well. In addition, the principle of Hangeul, which is formed by combining consonants and vowels, is equally applicable to Hangeul and Roman characters (English), so it is possible to implement a Japanese input device consisting of Hangeul and a Japanese input device consisting of English.

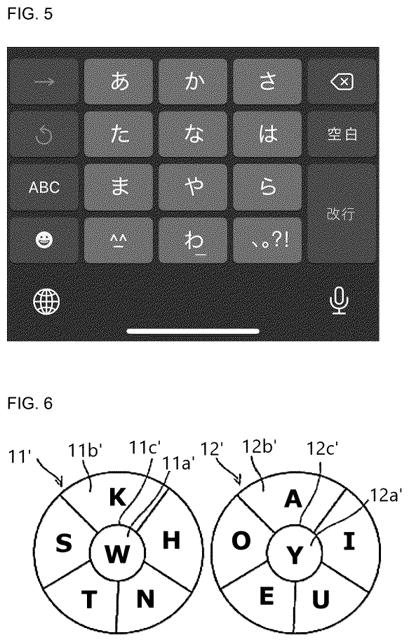

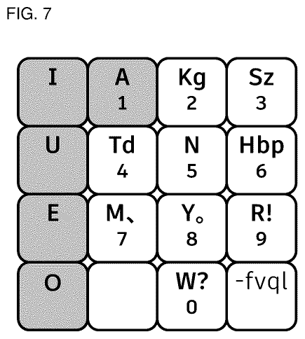

When a specific Japanese is input using the Japanese input device of FIG. 1, the order of key presses (touches) is as follows. It will be understood that the Japanese input method and order are the same as those described above. The Japanese input device of the prior art of FIG. 5 is also described together with comparison of the number of strokes.

TABLE 1

| | Input | | Number of |
|---|---|---|---|
| Input Japanese | device | Order of input keys | strokes |
| [symbol] | FIG. 5 | [symbol] | 27 |
| (Arigatogozaimasu) | FIG. 1 | [symbol] | 20 |

TABLE 2

| | Input | | Number of |
|---|---|---|---|
| Input Japanese | device | Order of input keys | strokes |
| [symbol] | FIG. 5 | [symbol] | 6 |
| (Gyu) | FIG. 1 | [symbol] | 5 |

TABLE 3

| | Input | | Number of |
|---|---|---|---|
| Input Japanese | device | Order of input keys | strokes |
| [symbol] | FIG. 5 | [symbol] | 11 |
| (Pot) | FIG. 1 | [symbol] | 3 |

TABLE 4

| | Input | | Number of |
|---|---|---|---|
| Input Japanese | device | Order of input keys | strokes |
| [symbol] | FIG. 5 | [symbol] | 42 |
| (Denwabang- | FIG. 1 | [symbol] | 26 |
| ouwananbandesuka) | | | |

As described above, various modifications are possible within the technical spirit of introducing a silent key and displaying Japanese syllables with an essential combination of consonants and vowels. For example, the silent key 6 may be placed on the second portion 4, or may be independently installed in a space between the first portion 2 and the second portion 4 or outside a separate key so as to be easily distinguished.

One of the advantages of the Japanese input device of the present invention is that the number of strokes or touches may be significantly reduced.

The arrangement of keys and keyboards in the Japanese input device is an example of an optimal arrangement, and various changes are possible. For example, the first portion 2 may be separately arranged on one side of the input device and the second portion 4 may be separately arranged on the other side of the input device, or a first device for the first portion and a second device for the second portion may be separately manufactured. It is obvious that the modification examples only differ in physical position and belong to the scope of the present invention in terms of input principle and structure.

### Embodiment for Japanese PC Keyboard

A second embodiment of a Japanese input device 1 will be described on the premise of the Japanese PC keyboard.

FIG. 2 shows the Japanese input device 1 of the PC keyboard according to the second embodiment of the present invention.

Although there are various types of existing Japanese input devices, the Japanese input device includes English consonants and vowels, and arrangement positions and orders thereof are the same.

In the Japanese input device 1 of the present invention, ten keys “Q”, “W”, “E”, “R”, “T”, “Y”, “U”, “I”, “O”, and “P” are also arranged in a first row E1 of an English keyboard, nine keys “A”, “S”, “D”, “F”, “G”, “H”, “J”, “K”, and “L” are arranged in a second row E2, and seven letters of “Z”, “X”, “C”, “V”, “B”, “N”, and “M” are arranged in a third row E3, which are the same as the existing keyboards. The total number of the English keys are 26. However, in FIG. 1, the numbers of keys in the first portion 2, the keys in the second portion 4, and the silent key 6 excluding the symbols and the comma are 15, 10, and 1, respectively, which are equal to the sum of the English keys.

Therefore, the core of the second embodiment is to arrange the 26 keys, which are the core of the first embodiment of the present invention, in the 26 English keys of the PC keyboard consistently with the first embodiment of the present invention and for the user's convenience.

For convenience of description, in FIG. 2, row and column numbers are assigned to English key positions, and for example, “Q” is indicated by E11 and “M” is indicated by E37.

In the present invention, Japanese keys are respectively designated for English key as follows.

TABLE 5

| | English | Japanese | | English | Japanese | | English | Japanese |
|---|---|---|---|---|---|---|---|---|
| Position | key | key | Position | key | key | Position | key | key |
| E11 | Q | | E12 | W | [symbol] | E13 | E | [symbol] |
| E14 | R | [symbol] | E15 | T | [symbol] | E16 | Y | [symbol] |
| E17 | U | [symbol] | E18 | I | [symbol] | E19 | O | [symbol] |
| E110 | P | [symbol] | E21 | A | [symbol] | E22 | S | [symbol] |
| E23 | D | [symbol] | E24 | F | • | E25 | G | [symbol] |
| E26 | H | [symbol] | E27 | J | [symbol] | E28 | K | [symbol] |
| E29 | L | [symbol] | E31 | Z | [symbol] | E32 | X | [symbol] |
| E33 | C | [symbol] | E34 | V | [symbol] | E35 | B | [symbol] |
| E36 | N | [symbol] | E37 | M | [symbol] | | | |

Then, as shown in FIG. 2, the first portion 2 includes portions E11 to E16 of the first row from “Q” to “Y”, portions E21 to E23 and E25 of the second row from “A” to “D” and “G”, and portions E31 to E35 of the third row from “Z” to “B”. In addition, the second portion 4 includes portions E17 to E110 of the first row from “U” to “P”, portions E26 to E29 of the second row from “H” to “L”, and portions E36 and E37 of the third row from “N” to “M”.

The first portion 2 and the second portion 4 are located separately to the left and the right, respectively. As long as the first portion 2 and the second portion 4 are separated as described above, the assignment of the Japanese keys in the first portion 2 or the second portion 4 may be modified in various ways other than those shown in Table 5. However, according to the study of the present inventors, the embodiment of FIG. 2 is convenient in terms of Japanese writing.

The silent key 6 is located in E24 inside a region surrounded by the first portion 2, and corresponds to an English key “F”. However, the silent key 6 may be installed elsewhere inside the first portion 2, installed inside the second portion 4, installed at a boundary between the first portion 2 and the second portion 4, or designated as an independent key other than 26 characters in English.

The auxiliary character 40 of the first embodiment may be indicated by a small letter on the key in the second portion 4, but it is not necessarily required in the second embodiment because the auxiliary character 40 may be indicated using other keys such as “SHIFT” due to the function of the keyboard. In addition, since the Japanese input device 1 is the PC keyboard, the arrangement and function of keys other than 26 characters in English may be arranged in various ways other than those shown in FIG. 2, which does not limit the scope of the present invention.

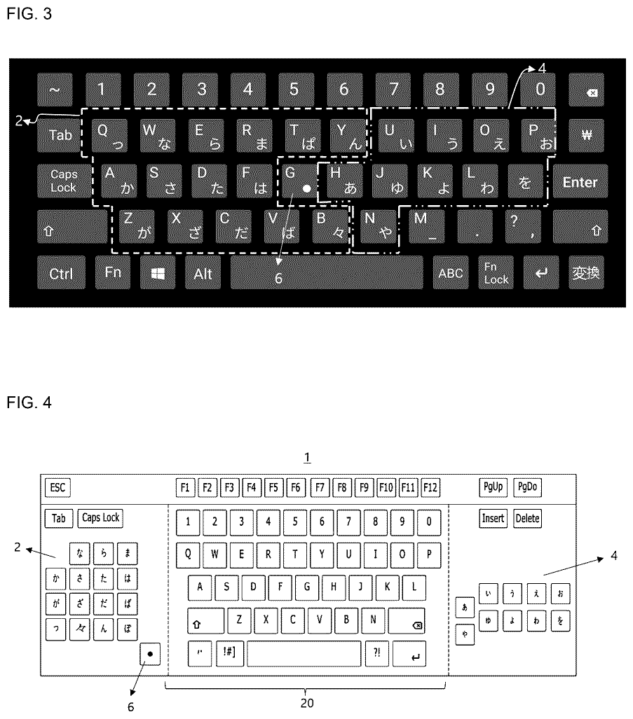

FIG. 3 shows the second embodiment of the Japanese input device 1 on the premise of the Japanese PC keyboard of the present invention. Unlike the previous embodiment, the portions of the first row from “Q” to “Y”, the portions of the second row from “A” to “F”, and the portions of the third row from “Z” to “B” are referred to as the first portion 2, and the portion corresponding to the key “G” is referred to as the silent key 6. The silent key 6 is assigned to a key provided at the boundary between the first portion 2 and the second portion 4.

Although the Japanese key designated to each English key is different from the previous embodiment, the same effect as the previous embodiment may be expected even if the Japanese key is configured in this way.

FIG. 4 shows a third embodiment of a Japanese input device 1 on the premise of the Japanese PC keyboard of the present invention.

The embodiment is different from the previous embodiment in that the English key is not used. As shown in the drawings, the first portion 2 is arranged on the left side of the keyboard, and the second portion 4 is arranged on the right side of the keyboard. The silent key 6 is located on the left side of the keyboard adjacent to the first portion 2. Consonants and vowels of Japanese are not assigned to an intermediate region 20 located between the first portion 2 and the second portion 4, and mainly consist of function keys, numbers, and English keys. It will be understood that an upper region on the first portion 2 and an upper region on the second portion 4 are keys related to functions and symbols required for typing in English and Japanese, and are similar to the arrangement of keys on the current keyboard.

In the embodiment, the first portion 2 and the second portion 4 are reliably separated from each other with the intermediate region 20 interposed therebetween. However, it is also possible to change the position by disposing the first portion 2 on the right side of the keyboard, or to match both the first and second portions 2 and 4 on the left or right side of the keyboard, unlike shown in the drawings.

The embodiment has the advantage of being appropriately changed and used as a gaming keyboard. That is, a game-dedicated key, a button, or a control lever for a game may be provided in the intermediate region 20, and the first portion 2 and the second portion 4 may be installed on both sides separately or may be installed in a group on one side for a conversation during the game.

The scope of the present invention extends to the same or equivalent scope as the claims described below.

1. A PC keyboard comprising a Japanese input device,
wherein the Japanese input device includes:
a first portion for inputting consonants;
a second portion for inputting vowels; and
a silent key for indicating Japanese syllables in combination with keys [symbol] [symbol] in the second portion,
wherein the Japanese syllables are indicated using (a) consonant keys in the first portion and vowel keys in the second portion, or (b) the silent key and the vowel keys in the second portion, in which the syllables are not indicated when only one vowel key in the second portion is used, and
wherein the consonant keys in the first portion and the vowel keys in the second portion are installed to correspond to English keys of the PC keyboard, and the first portion and the second portion are arranged such that a region surrounding the first portion and a region surrounding the second portion do not cross or overlap each other to allow the first portion and the second portion to occupy independent regions on the PC keyboard, respectively.

2. The PC keyboard of claim 1, wherein the consonant keys in the first portion, the vowel keys in the second portion, and the silent key are installed to correspond to the English keys of the PC keyboard.

3. The PC keyboard of claim 2, wherein the consonant keys in the first portion consist of at least 15 keys including keys [symbol] .

4. The PC keyboard of claim 2, wherein the vowel keys in the second portion consist of at least 10 keys including the keys [symbol] .

5. A PC keyboard comprising a Japanese input device,
wherein the Japanese input device includes:
a first portion for inputting consonants;
a second portion for inputting vowels; and
a silent key for indicating Japanese syllables in combination with keys [symbol] [symbol] in the second portion,
wherein the Japanese syllables are indicated using (a) consonant keys in the first portion and vowel keys in the second portion, or (b) the silent key and the vowel keys in the second portion, and the syllables are not indicated when only one vowel key in the second portion is used, and
wherein the Japanese input device is installed at a position that does not overlap with the English keys of the PC keyboard, and the first portion and the second portion are arranged to allow the first portion and the second portion to occupy independent regions on the PC keyboard, respectively.

6. The PC keyboard of claim 5, wherein the first portion is arranged on one side of the PC keyboard, the second portion is arranged on the other side of the PC keyboard, and the English keys are arranged in an intermediate region between the first portion and the second portion.

7. A gaming keyboard comprising a Japanese input device,
wherein the Japanese input device includes:
a first portion for inputting consonants;
a second portion for inputting vowels; and
a silent key for indicating Japanese syllables in combination with keys [symbol] [symbol] in the second portion,
wherein the Japanese syllables are indicated using (a) consonant keys in the first portion and vowel keys in the second portion, or (b) the silent key and the vowel keys in the second portion, in which the syllables are not indicated when only one vowel key in the second portion is used, and
wherein the consonant keys in the first portion and the vowel keys in the second portion are arranged to allow the consonant keys and the vowel keys to occupy independent regions on the gaming keyboard, respectively.

8. The gaming keyboard of claim 7, wherein the first portion is arranged on one side of the gaming keyboard, the second portion is arranged on the other side of the gaming keyboard, and a game-dedicated key or a controller is installed in an intermediate region between the first portion and the second portion.
